(19) United States
(12) Patent Application Publication
(10) Pub. No.: US 2010/0257804 A1
(43) Pub. Date: Oct. 14, 2010

(54) Frameless shutter

(76) Inventor: David Blachley, Newport Beach, CA (US)

Correspondence Address: LAW OFFICE OF GLENN R. SMITH, 28626 BROOKHILL ROAD, TRABUCO CANYON, CA, 92679-1163, US

(21) Appl. No.: 11/901,701

(22) Filed: Sep. 17, 2007

Related U.S. Application Data
(60) Provisional application No. 60/845,379, filed on Sep. 16, 2006.

(51) Int. Cl. E06B 7/08

(52) U.S. Cl. 52/473

(57) ABSTRACT

A frameless shutter has a shutter panel having stiles and spreaders that accommodate louvers that rotate so as to open and close the shutter panel. An installation plate is mounted within a window opening. A concealable hinge has a shutter mount fixedly attached to the shutter panel back side and a plate mount fixedly attached to the installation plate. The shutter mount and the plate mount removably attach to mount the shutter panel over the window opening. A window frame is mounted to a wall having the window opening so as to surround and decorate the shutter panel.

### CROSS-REFERENCE TO RELATED APPLICATIONS

This application relates to and claims the benefit of U.S. Provisional Application No. 60/845,379 entitled Frameless Shutter, filed Sep. 16, 2006 and hereby incorporated by reference herein.

### BACKGROUND OF THE INVENTION

Shutters are a high quality interior window treatment, having a combination of style, functionality and elegance that sets them apart from other window coverings. Shutters provide warmth in the winter and protect from damaging heat and sunlight in the summer. Conventional shutters are made of an indigenous wood such as popular, oak or ash. The shutter components are typically assembled using doweling, screws and staples. After assembly, the shutters are stained or painted.

FIGS. 1-2 illustrate a conventional shutter assembly 100 having a window frame 101, mortised hinges 110 and a shutter panel 200. The window frame 101 is attached around a window opening, typically using a nail gun to drive nails through the window frame into the facing wall. The shutter panel 200 is then mounted to the window frame with the hinges 110, allowing the shutter panel 200 to swing open or closed. The shutter panel 200 has stiles 210, spreaders 220, louvers 230 and a tilt bar 240. The louvers 230 are rotatably mounted to the stiles 210 using standard louver pins 250. The tilt bar 240 is linked to the leading edge of the louvers 230 with an interlocked tilt bar link 260 and louver link 270 and operable up and down so as to rotate the louvers 230 to various positions. The louvers 230 have a closed position with the tilt bar 240 in a fully up position and the louvers 230 overlapping along the edges so as to block light from passing through the opening 204. The louvers 230 also have various open positions with the tilt bar 240 positioned away from the fully up position and the louvers 230 rotated away from the plane of the opening so as to allow light to pass.

### SUMMARY OF THE INVENTION

Conventional shutter installation is costly and inconvenient. Windows are not exactly square, and a professional carpenter is needed to install and square the window frame and patch the corner gaps and nail holes that result. Further, these patches are often visible. Also, conventional shutters have exposed mortised hinges, which are unsightly and have metal surfaces that are difficult to paint or otherwise match to the surrounding shutter material. In addition, conventional shutters are manufactured and assembled at a relatively few number of locations and then shipped in large crates to their destination, at significant expense. Also, shutters are traditionally manufactured from indigenous woods are costly to prepare for assembly, are not amenable to modern coating processes, and are not durable enough during assembly to allow prefinishing.

A frameless shutter is advantageously mounted with concealed hinges to a window casement, either directly or via a preset/pre-aligned hinge plate, eliminating costly framing and professional installation. Further, the frameless shutter advantageously incorporates “snap-in” parts so as to facilitate consumer assembly, mass assembly into manufactured homes or otherwise friendly end-user assembly and installation. In addition, the frameless shutter is advantageously adapted to be packaged as a relatively small, light-weight, ready-to-assemble (RTA) kit that can be inexpensively transported, shipped or otherwise distributed, in whole or in part. In one embodiment, a frameless shutter is manufactured from prefinished fiberboard components, which is a less expensive material than indigenous wood, is less costly to prepare, has a suitable surface for modern laminates and is durable enough during assembly to allow prefinishing. One embodiment also utilizes a cost reduction “tree” component that facilitates snap-in assembly of removable louvers, profoundly reducing a majority of the manufacturing steps required for traditional shutters and reducing the cost of machinery, manufacturing floor space and skilled employees.

### BRIEF DESCRIPTION OF THE DRAWINGS

FIGS. 1-2 are front perspective assembled and exploded views, respectively, of a conventional shutter panel and associated window frame;

FIGS. 3-4 are closed and open views, respectively, of a frameless shutter embodiment;

FIGS. 5A-B are front perspective assembled and exploded views, respectively, of a frameless shutter embodiment;

FIG. 6 is a perspective, exploded view of a frameless shutter portion including a spreader, stile, screw-in anchor and associated locking cam;

FIGS. 7A-D are various views of a spreader, stile, screw-in anchor and hinge mount;

FIG. 8 is a perspective view of an installation plate including hinge mounts;

FIG. 9 is a front view of a window frame separately mounted around a frameless shutter;

FIG. 10 is an exploded back view of a window frame for separately mounting around a frameless shutter;

FIG. 11 is a back view of another window frame embodiment;

FIG. 12 is a perspective view of a wall plate for a window frame;

FIG. 13 is a cross-sectional perspective view of a window frame;

FIG. 14 is a cross-sectional end view of a window frame and frame plate; and

FIGS. 15A-C are perspective, cross-sectional and cross-sectional perspective views, respectively, of alternative embodiments of a wall plate and window frame.

### DETAILED DESCRIPTION OF THE PREFERRED EMBODIMENTS

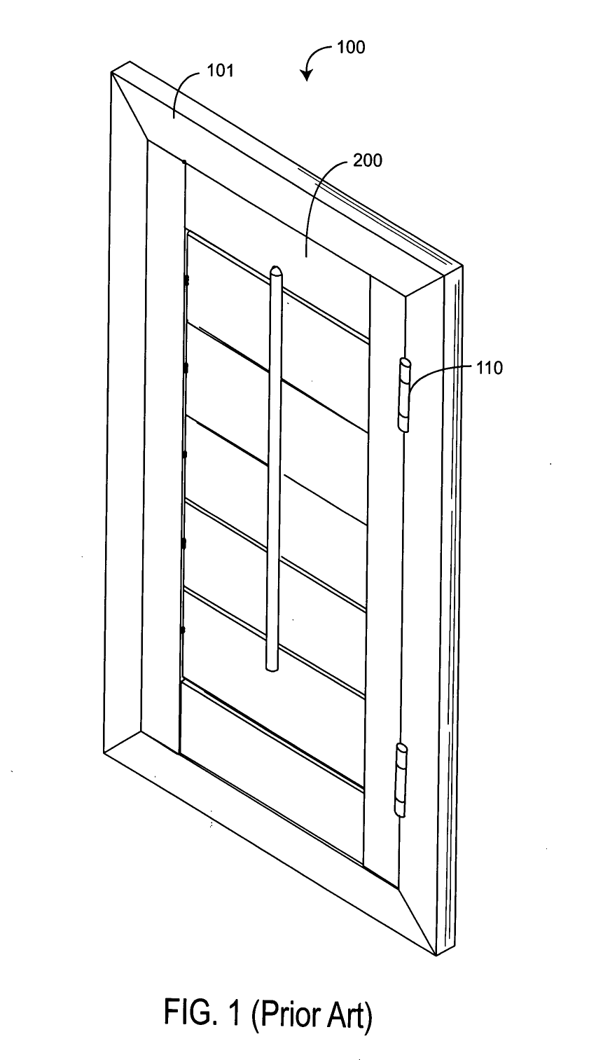

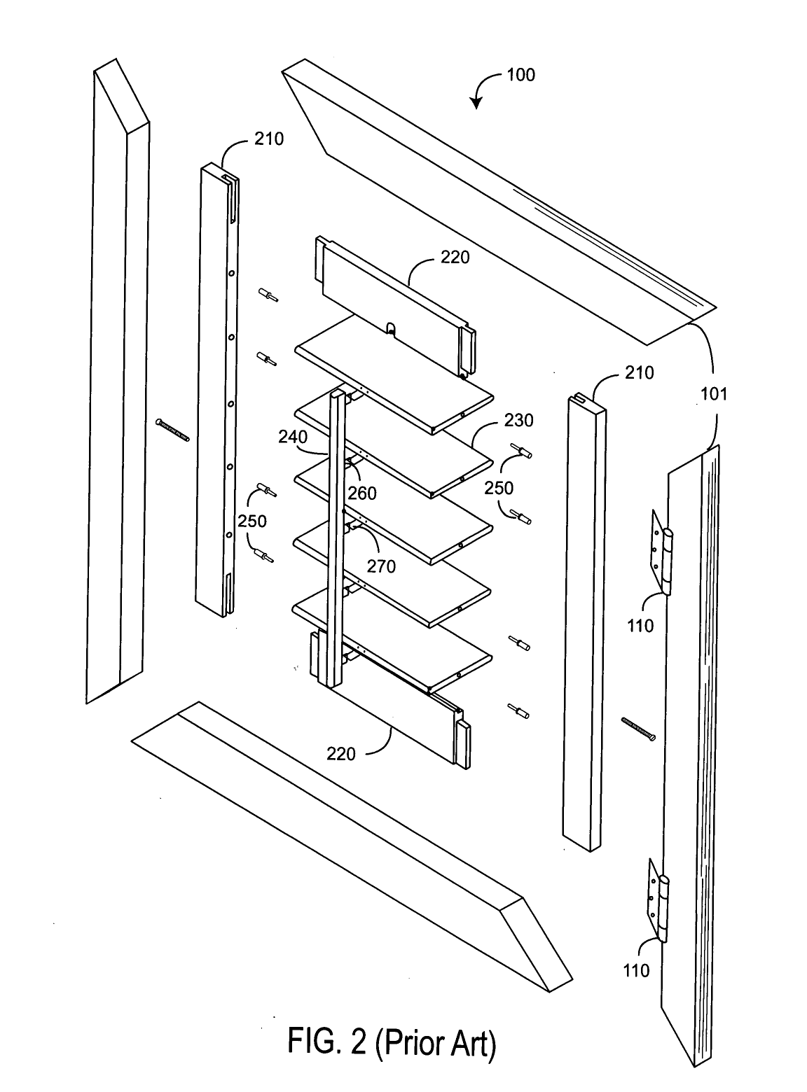

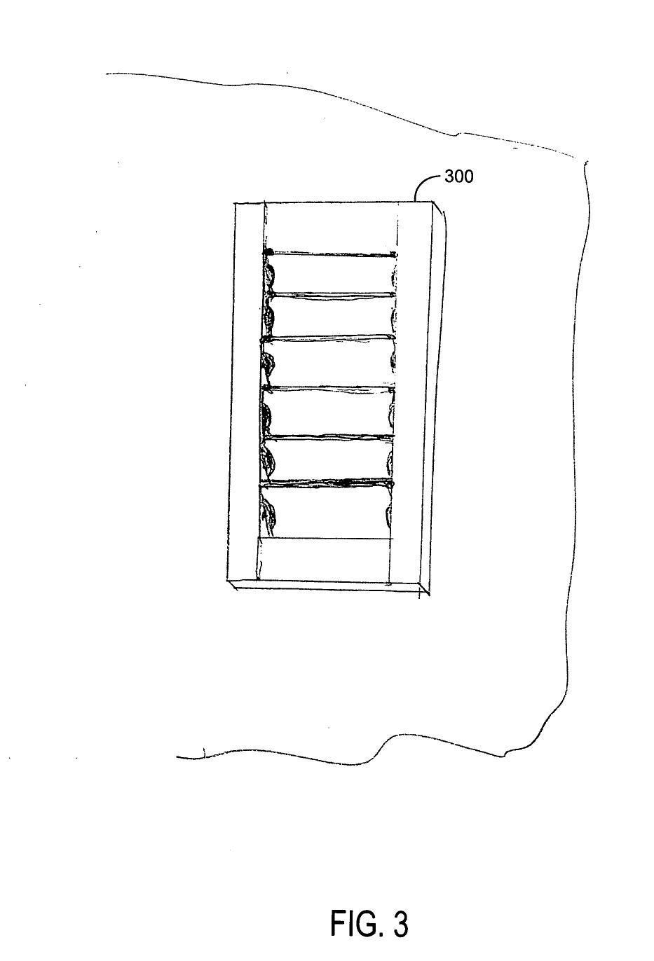

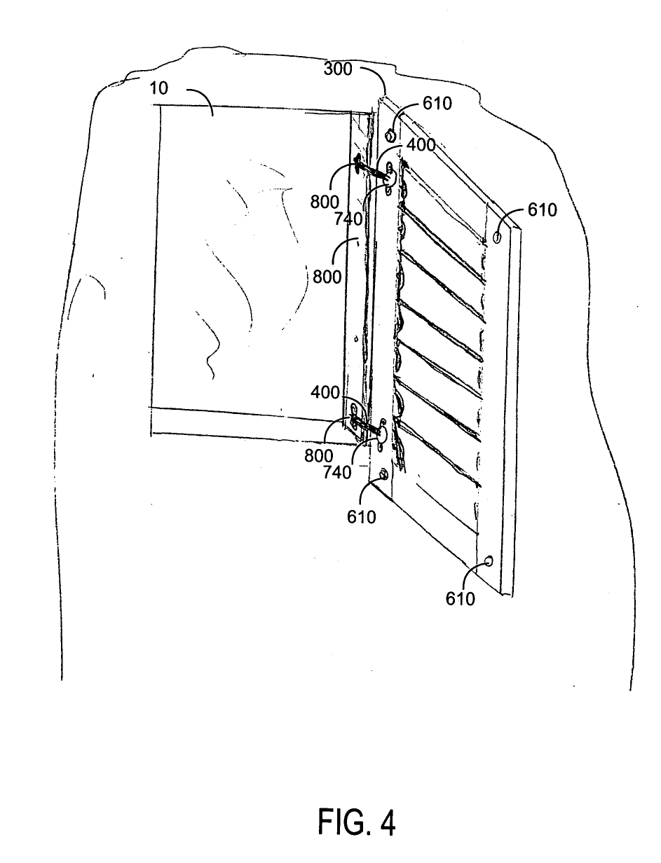

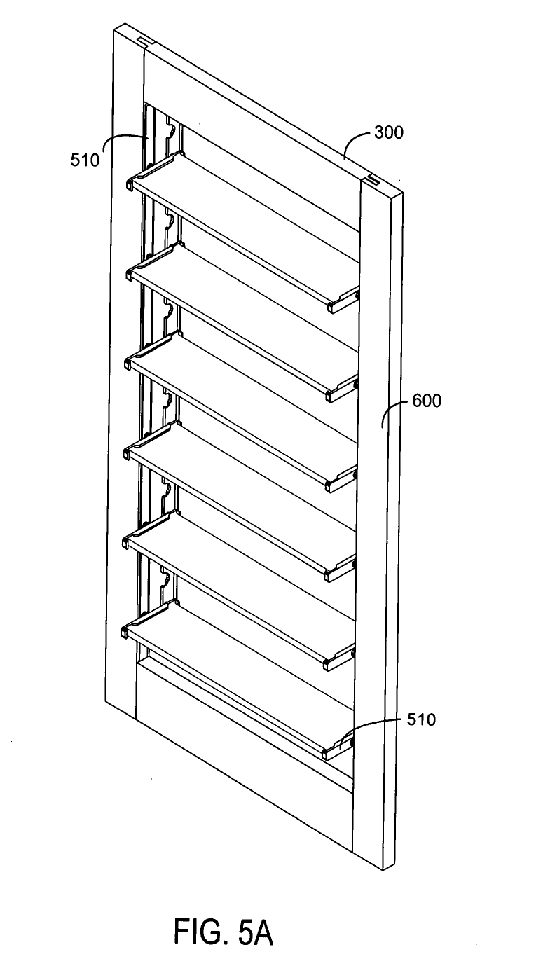

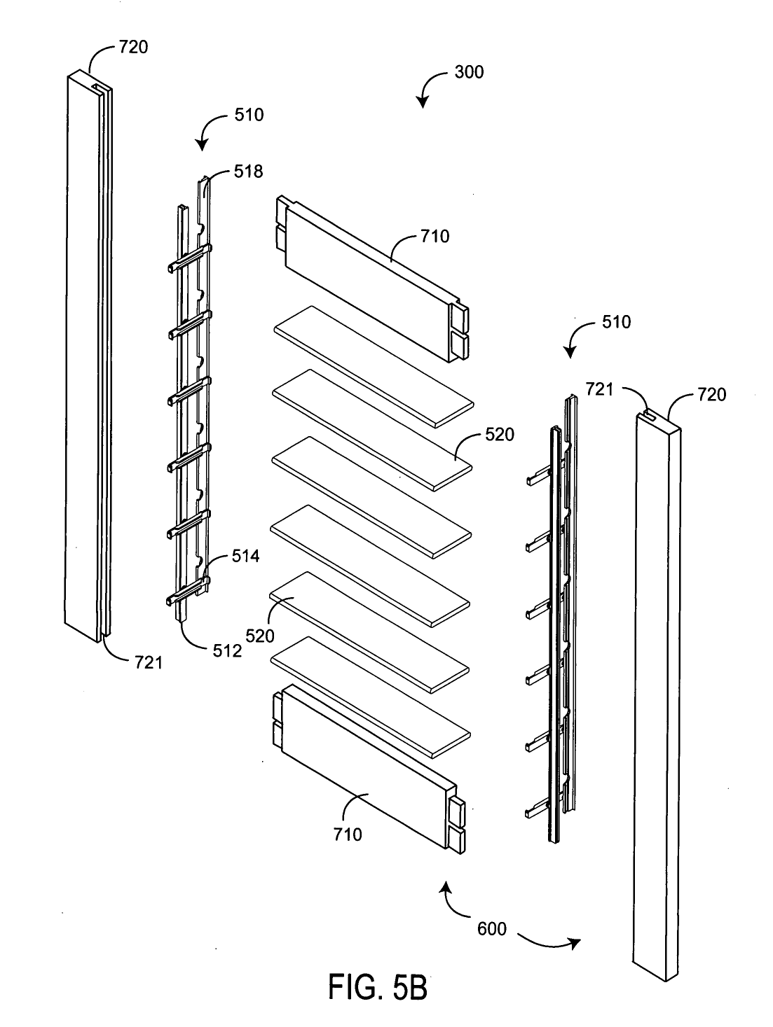

FIGS. 3-4 illustrate a frameless shutter 300 embodiment advantageously having concealed hinges 400 and mounted to a window opening 10 without the necessity of a window frame 101 (FIGS. 1-2). In one embodiment, not shown, a frameless shutter can have a decorative profile added to the panel frame 600 (FIG. 5B), such as with a machine that performs shaping, sanding and foiling steps in a single pass. The decorative profile can be any of a majority of those implemented on conventional window frames. Thus, the frameless shutter 300 may eliminate the traditional window frame yet retain the aesthetics of the window frame decorative designs.

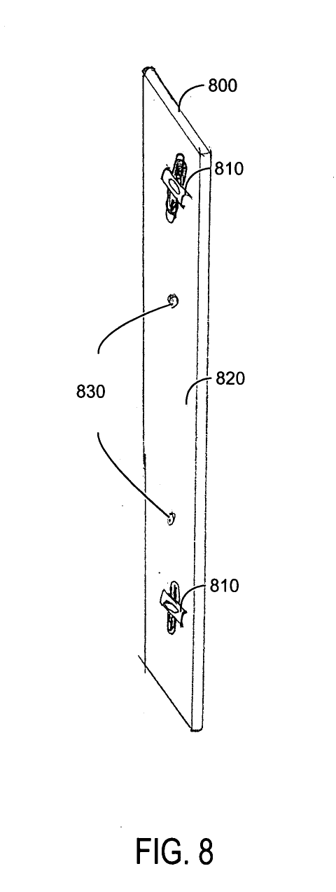

As shown in FIG. 4, the frameless shutter 300 uses an installation plate 800 to mount a shutter 300 to the window opening 10. The concealed hinges 400 have detachable shutter mount 740 and plate mount 810 portions. These hinge portions 740, 810 are initially unattached for mounting the installation plate 800 to the window opening 10. The hinge portions 740, 810 then attach to pivotably mount the shutter 300 to the installation plate 800, so that the shutter can move between an open position FIG. 4 and a closed position FIG. 3. Concealable hinges, such as European-Style hinges, are available from Blum Inc., Stanley, N.C. 28164. The installation plate 800 is described with respect to FIG. 8, below.

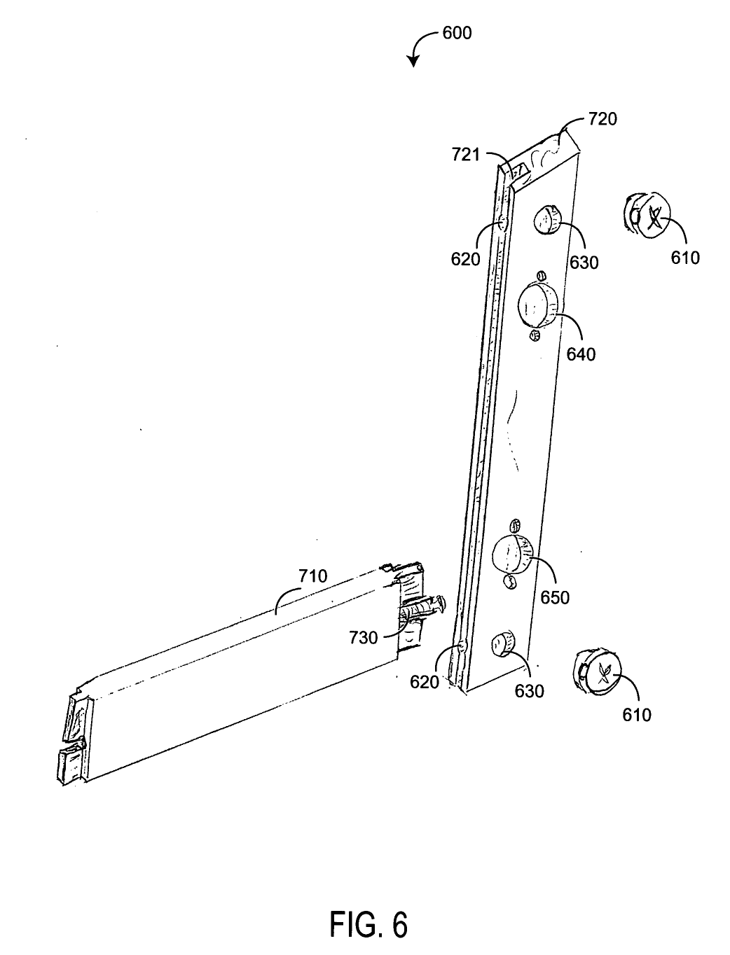

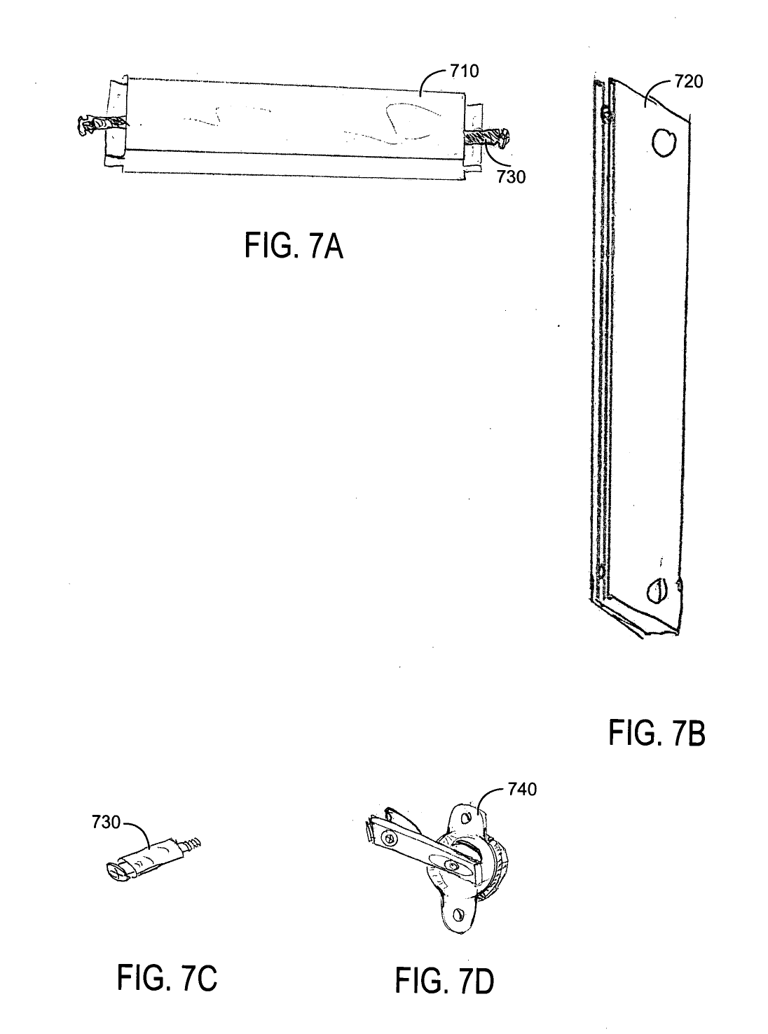

FIGS. 5A-B further illustrate a frameless shutter 300 including a panel frame 600, preassembled louver clip “trees” 510 and removable louvers 520. The panel frame 600 has spreaders 710 and stiles 720. The stiles 720 have full-length grooves that accommodate the trees 510. The trees 510 each have an insert 512, louver clips 514 and a tilt bar 518. The inserts 512 attach the trees 510 to the stile grooves 721. The louver clips 514 removably attach the louvers 520 within the panel frame 600. The tilt bars 518 simultaneously rotate the louvers so as to open and close the louvers 520 within the panel frame 600. Panel frame 600 assembly is described with respect to FIGS. 6-7, below. Louver clip trees 510 are described in U.S. patent application Ser. No. 11/079,535 entitled Ready To Assemble Shutter, filed Mar. 12, 2005, invented by the inventor of the current invention and incorporated by reference herein. In one embodiment, the panel frame 600, hinge plate 800 and louvers 520 are constructed of prefinished fiberboard, such as described in U.S. Pat. No. 6,622,433 entitled Prefinished Medium Density Fiberboard Shutter, invented by the inventor of the current invention and incorporated by reference herein.

FIG. 6 illustrates assembly of a panel frame 600 having spreaders 710, stiles 720, anchors 730 and cam-locks 610. The anchors 730 screw into each end of the spreaders 710. The spreaders 710 insert into the grooves 721 of the spreaders 720 and into cavities 620 that accommodate the anchors 730 at each end of the spreaders 720. The cam locks 610 insert into cam apertures 630 on the stile faces, engage the anchors 730 and twist so as to secure the spreaders 710 to the stiles 720, meshing and locking the ends of these components into a panel frame 600.

FIGS. 7A-D further illustrate the panel frame 600 components, including a spreader 710 with anchors 730 attached at each end and a stile 720. Further shown are an anchor 730 and a shutter mount 740 portion of a hinge 400 (FIG. 4).

FIG. 8 illustrates an installation plate 800 having plate mount 810 portions of a hinge 400 (FIG. 4). The plate mounts 810 are fixedly attached to a plate 820 that attaches to the side of a window opening with screws, nails or similar fasteners inserted through corresponding plate apertures 830.

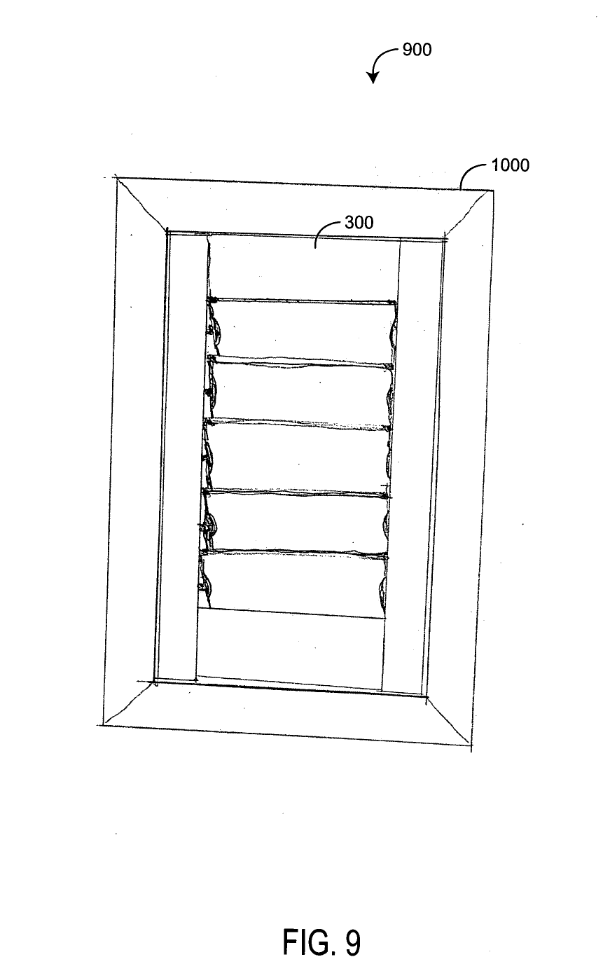

FIG. 9 illustrates a decorative window frame 1000 that is advantageously separately and optionally mounted around the periphery of an installed frameless shutter 300. Window frames 1000 can be attached to a wall at the window opening without professional installation using Velcro®, 2-sided tape such as available from 3M® or similar conventional attachment mechanisms.

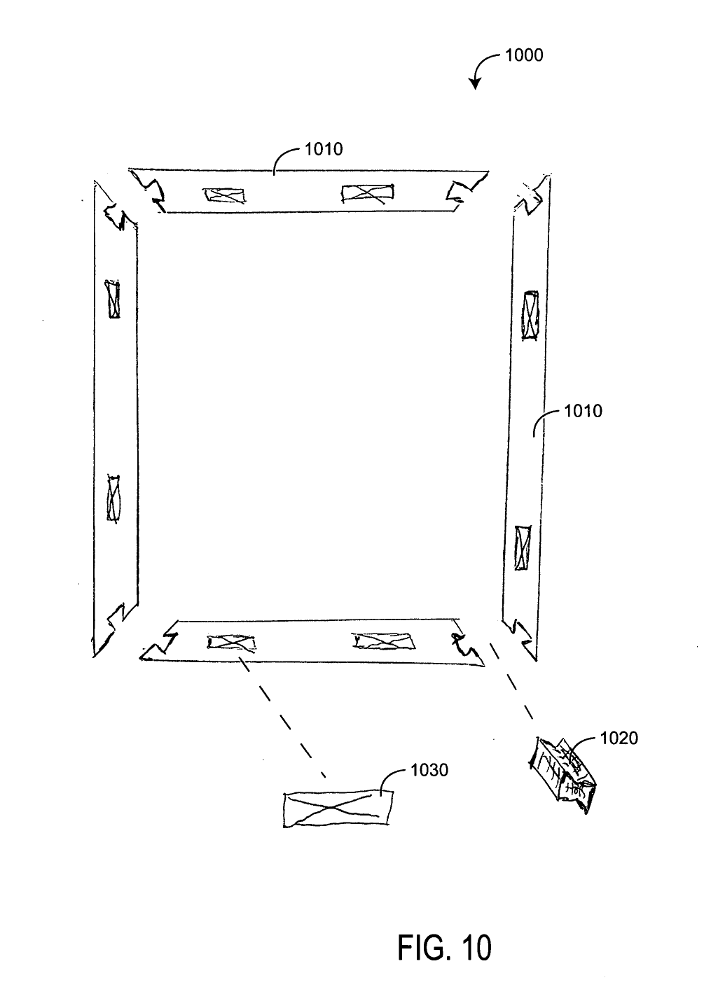

FIG. 10 illustrates assembly of a window frame 1000 having frame components 1010. In one embodiment, the window frame components 1010 are advantageously constructed of wood or fiberboard wrapped with a decorative paper The frame components 1010 are attached at the corners with press-fit connectors, such as the keys shown, available from Hoffmann Machine Company, Inc., Bohemia, N.Y. 11716.

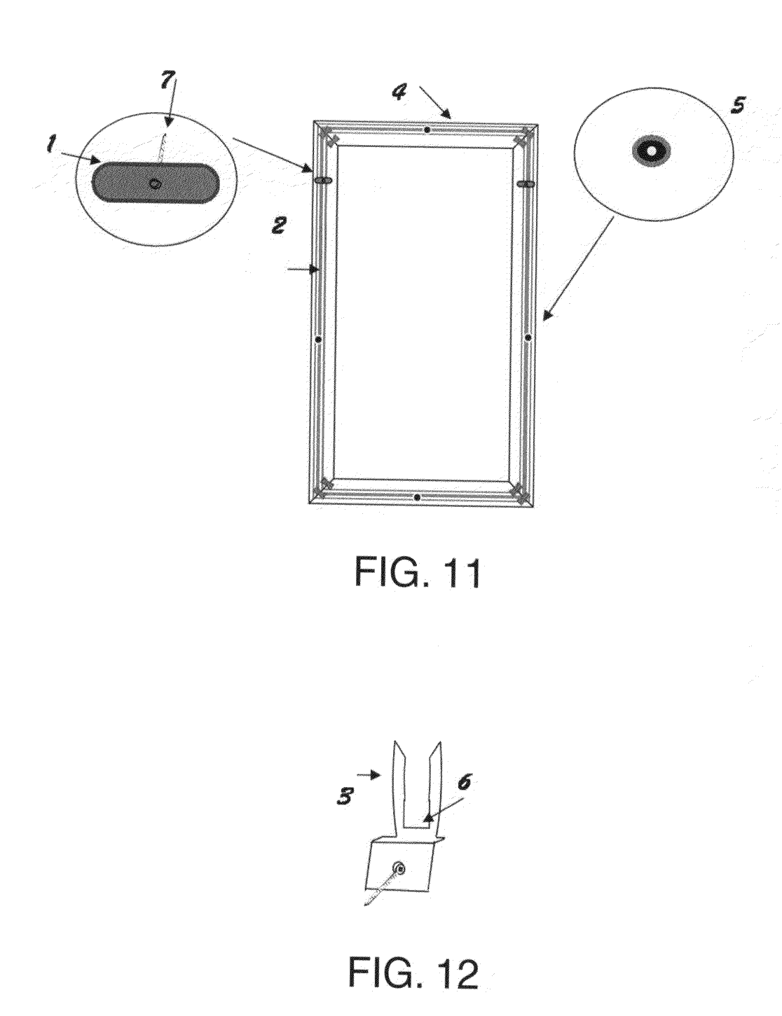

FIGS. 11-12 illustrate another window frame embodiment including a window frame 4 and wall plate 3. Wall plates 3 screw to a wall, and the frame 4 removably attaches to the wall plates 3 at the frame plates 1. Bottom corners and sides of the frame 4 are affixed utilizing predrilled holes 5. The window frame can be replaced and easily installed using only a screwdriver, which eliminate the need for professional installation skills as required for traditional shutters.

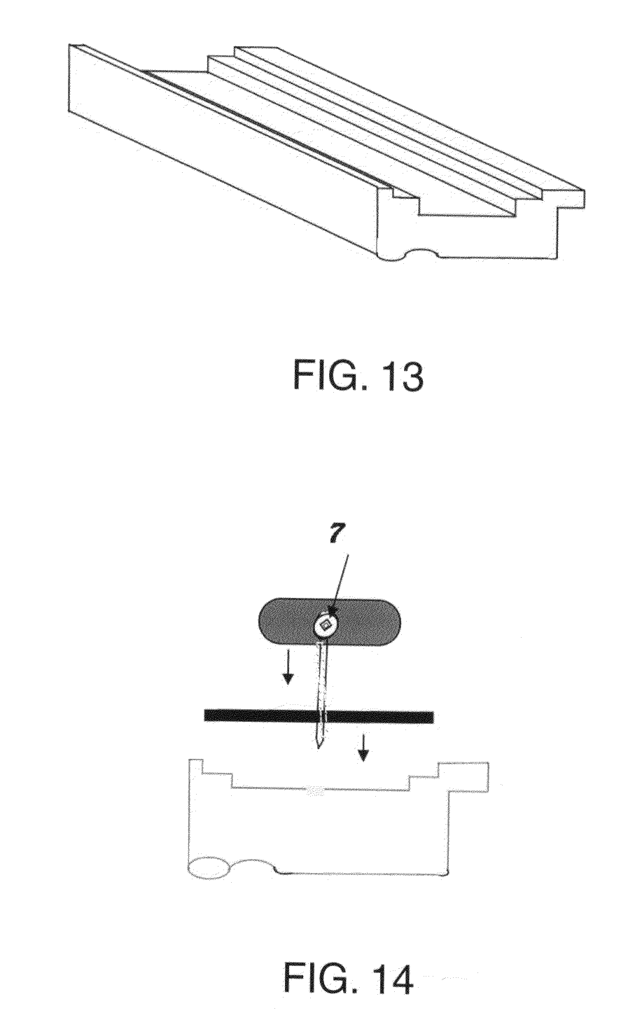

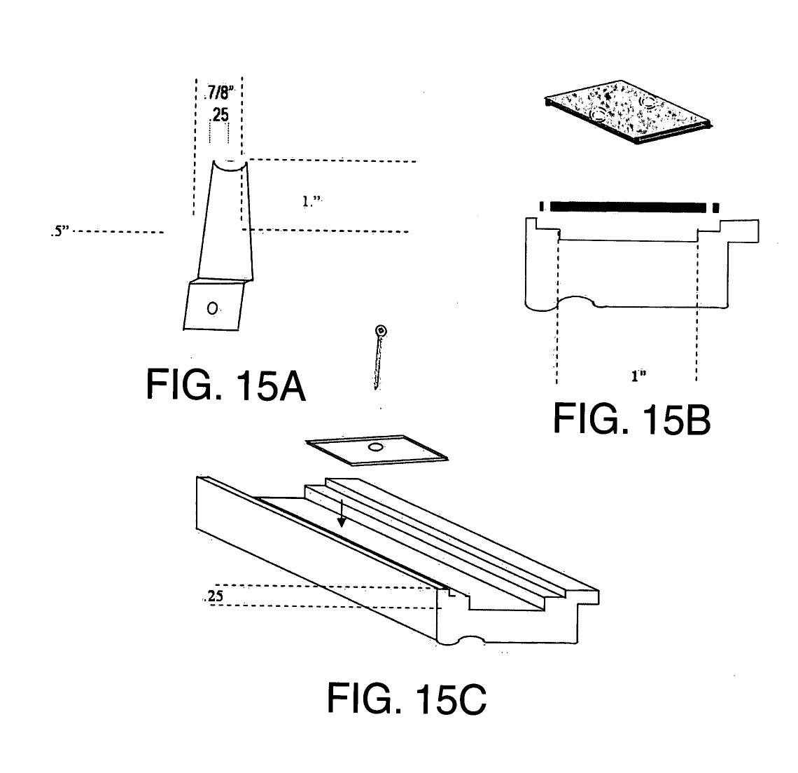

As shown in FIGS. 11, 13 and 14, frame plates 1 screw into pre-milled slot guides 2. The slot guides 2 are milled as the overall frame profile is being made, resulting in no additional manufacturing costs. The wall plates 3 are screwed to a wall, and the frame 4 is guided along the pre-milled channels 2 so that the wall plates 3 attach behind the frame plates 1. The wall plate fork 6 surrounds the frame plate screw 7. A gap in the wall plate fork 6 allows excess play along the frame plate 1 for installation adjustment (racking). FIGS. 15A-B illustrate other wall plate and frame plate embodiments.

A frameless shutter has been disclosed and described above in detail in connection with various embodiments. These embodiments are disclosed by way of examples only and are not to limit the scope of the claims that follow. One of ordinary skill in art will appreciate many variations and modifications.

1. A frameless shutter comprising:
a shutter panel having stiles and spreaders that accommodate louvers that rotate so as to open and close the shutter panel, the shutter panel having a front side and a back side;
an installation plate mounted within a window opening;
a concealable hinge having a shutter mount fixedly attached to the shutter panel back side and a plate mount fixedly attached to the installation plate; and
the shutter mount and the plate mount removably attach to mount the shutter panel over the window opening.

2. The frameless shutter according to claim 1 further comprising:
a plurality of anchors that screw into each end of the spreaders;
a plurality of cam locks that insert into corresponding cam apertures disposed in the stiles; and
the cam locks engage the anchors so as to secure the spreaders to the stiles.

3. A shutter assembly comprising:
a shutter panel having stiles and spreaders that accommodate louvers that rotate so as to open and close the shutter panel;
the shutter panel has a front side and a back side;
an installation plate mounted to the side of a window opening that is disposed through a wall;
a concealable hinge having a shutter mount fixedly attached to the shutter panel back side and a plate mount fixedly attached to the installation plate; and
the shutter mount and the plate mount removably attach to mount the shutter panel over the window opening;
a window frame mounted to the wall and disposed around the periphery of the window opening and the mounted shutter panel so as to decorate the shutter panel; and
the shutter panel unattached to the window frame.

4. The shutter assembly according to claim 3 wherein the window frame is attached to the wall with a two-sided tape.
